(19) United States
(12) Patent Application Publication
(10) Pub. No.: US 2023/0336696 A1
(43) Pub. Date: Oct. 19, 2023

(54) GROUND SENSOR-TRIGGERED SATELLITE IMAGE CAPTURE

(71) Applicant: Microsoft Technology Licensing, LLC, Redmond, WA (US)

(72) Inventors: Tusher CHAKRABORTY, Bangalore (IN); Ranveer CHANDRA, Kirkland, WA (US)

(21) Appl. No.: 17/722,273

(22) Filed: Apr. 15, 2022

(51) Int. Cl. H04N 7/18; H04N 5/232; G06V 10/80

(52) U.S. Cl. CPC H04N 7/188; H04N 5/23222; G06V 10/803; H04N 7/183

(57) ABSTRACT

The disclosure herein describes triggering image capture requests at ground Internet-of-Things (IoT) devices based on sensor events, and processing the image capture requests by satellites. An image capture request is received by the satellite from a ground IoT device. An image capture request includes request type data, location data, and response target data. The request type data is indicative of a sensor event at the ground IoT device. Image data is captured using an image capture device of the satellite. The image data is of an area based on the location data. A response to the request is generated based on the captured image data and the request type data, and the generated response is sent to the response target based on the response target data of the image capture request. The disclosure enables satellites to efficiently respond to a wide variety of image capture requests from ground IoT devices.

### BACKGROUND

Satellite technology provides an important platform for data communications, image capture, and the like. Earth Observation (EO) satellites are widely used for a variety of applications in several domains including agriculture, energy, maritime, and environmental monitoring. However, in many of these applications, limitations of current infrastructure present several challenges. Monitoring a region through continuous satellite image capture is expensive in terms of cost, time, and bandwidth. Further, in some applications, the captured image data does not provide enough reliability and precision on its own. Additional processing is required to generate useful insights. Still further, satellite revisit time is often high due to a low quantity of satellites in a dedicated constellation, which increases latency.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for processing and responding to image capture requests by a satellite is described. An image capture request is received by the satellite from a ground Internet-of-Things (IoT) device. The image capture request includes request type data, location data, and response target data. Further, the request type data is indicative of a sensor event at the ground IoT device. Image data is captured using an image capture device of the satellite. The image data is of an area based on the location data of the request. A response to the request is generated based on the captured image data and the request type data and the generated response is sent to the response target based on the response target data of the image capture request.

### BRIEF DESCRIPTION OF THE DRAWINGS

The present description will be better understood from the following detailed description read in light of the accompanying drawings, wherein:

FIG. 1 is a block diagram illustrating a system configured to capture image data using satellites based on trigger events detected at ground Internet-of-Things (IoT) devices;

FIG. 2 is a sequence diagram illustrating a process of capturing image data by a satellite based on an image capture request from a ground IoT device;

FIG. 3 is a sequence diagram illustrating a process of capturing image data of a field by a satellite based on an image capture request from a ground IoT device associated with collected water level sensor data;

FIG. 4 is a diagram illustrating a structure of an image capture request from a ground IoT device;

FIG. 5 is a flowchart illustrating a method for processing and responding to an image capture request by a satellite;

FIG. 6 is a flowchart illustrating a method for processing and responding to image capture requests based on captured image data and associated sensor data;

FIG. 7 is a diagram illustrating an initial circular area of interest, an associated polygonal area of interest, and sensor devices associated with the area of interest; and

FIG. 8 illustrates an example computing apparatus as a functional block diagram.

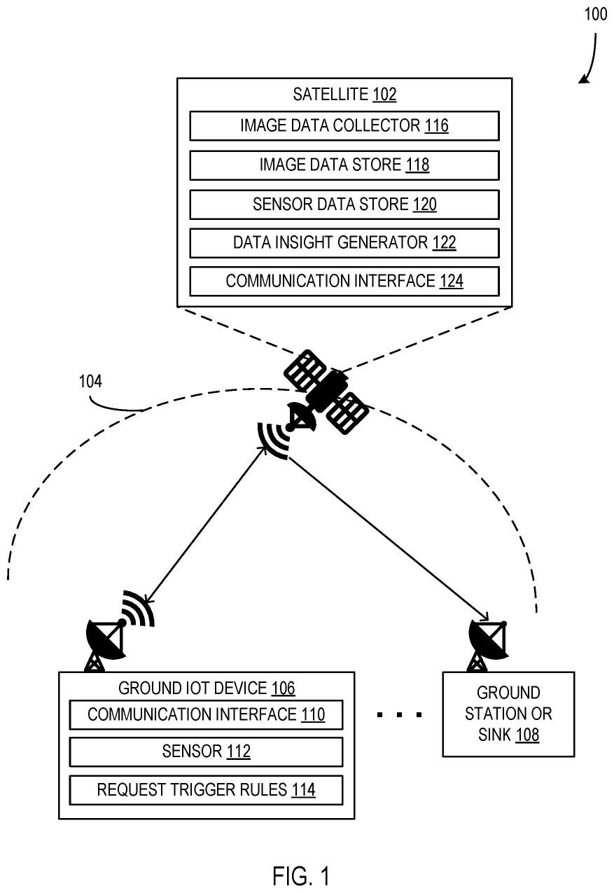

Corresponding reference characters indicate corresponding parts throughout the drawings. In FIGS. 1 to 8, the systems are illustrated as schematic drawings. The drawings may not be to scale.

### DETAILED DESCRIPTION

Aspects of the disclosure provide a computerized method and system for generating image capture requests at ground Internet-of-Things (IoT) devices based on sensor events, and processing and responding to the image capture requests at satellites. The ground IoT devices detect sensor events based on collected sensor data (e.g., ground truth data), such that image capture requests are sent in response to the detected sensor events. Satellites receive the image capture requests, process the received requests, and send responses to the received requests. The requests include data used by the satellites to process the requests, such as request type data indicative of the type of sensor event that triggered the request, location data indicative of the region for which the image is to be captured, and response target data that identifies at least one target to which a response will be sent. The satellites capture image data of a geographical area based on the location data and generate responses based on the captured image data. In some examples, sensor data is also obtained, and the responses are generated to include combinations (e.g., fusion) of the image data and sensor data. The generated responses are sent to the response targets as indicated by the response target data in the requests.

The disclosure operates in an unconventional manner at least by establishing a Direct-to-Satellite (DtS) IoT constellation of satellites that receive and process the described image capture requests. The constellation includes satellites with varying image capture capabilities (e.g., satellites that capture images in different spectrums). Because the satellites receive and respond to image capture requests as described, the disclosure enables ground IoT devices to directly trigger an image capture process by a satellite based on current ground sensor data (e.g., temperature data, soil moisture level data, water level data, or the like).

Further, the disclosure enables the satellites of the constellation to perform data processing operations such as combining ground sensor data and image data into combined data sets and/or data-enhance images, or generating insights based on the image data and/or sensor data (e.g., instructions to devices in the area based on analysis of sensor data).

Additionally, or alternatively, the disclosure enables the satellites of the constellation to send responses directly to the source ground IoT device of the request and/or other associated devices, rather than ground stations or sinks that are farther away, decreasing the time required for ground IoT devices to receive responses to requests.

The disclosure provides hyper-localized image capture based on ground sensor data events that reduces computing resource usage (e.g., bandwidth, memory, and processor usage) at the satellite. For example, images are captured only when the sensor data events take place, or are imminent based on the data collected by the ground IoT device or sensors associated therewith. As a result, the disclosure facilitates large spatial coverage of the Earth's surface (or other planet, moon, or body) with a decreased quantity of required sensor devices.

Further, the disclosure provides higher precision and reliability of responses to requests based on satellites being capable of merging ground sensor data with captured image data to generate the responses. Merging reduces the amount of data to convey to ground IoT devices (e.g., from megabytes to kilobytes), thereby improving resource management on the satellites and ground IoT devices. Ground IoT devices are enabled to automatically request such a response from satellites overhead and rapidly receive a response that is based on the local sensor data of the ground IoT devices. In this manner, the ground IoT devices automatically trigger image capture based on local knowledge (e.g., via a sensor of the ground IoT device) to get a wide view on an event of interest occurring at the location of the ground IoT device.

Additionally, the disclosure enables the quantity of data in responses to be reduced, as the satellites generate combined sensor-image data that can be compressed or otherwise generated to include less data than raw image data captured by the satellites. Alternatively, the satellites send insight data generated from analysis of the image data and/or sensor data, rather than the image data itself. This further reduces bandwidth usage and increases efficiency of computing resource usage at both the satellite and the ground IoT device.

FIG. 1 is a block diagram illustrating a system 100 configured to capture image data using satellites 102 based on trigger events detected at ground IoT devices 106. The satellites 102 are in an orbit 104 around the Earth or other body in space (e.g., Earth's moon, Mars, etc.) and receive image capture requests from the ground IoT devices 106 and/or other devices. Further, the satellites 102 capture and process image data and to provide responses to image capture requests to the same or different ground IoT devices 106 or other devices (e.g., ground station or sink 108) located elsewhere. Then, in some examples, the data of the responses is routed from the receiving ground sinks and/or stations to destinations via the Internet or other network(s). It should be understood that, while the diagram includes a single satellite 102, ground IoT device 106, and ground station or sink 108, in other examples, more, fewer, or different quantities and configurations of such components are included in the system 100 without departing from the description.

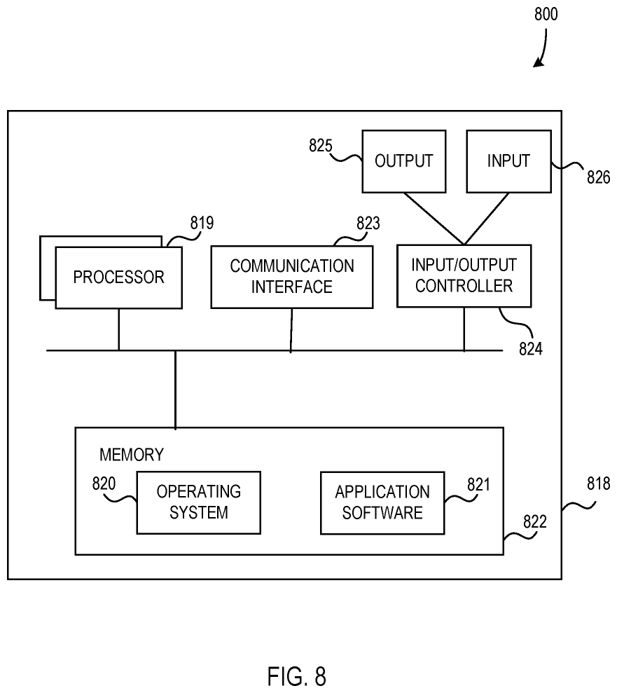

In some examples, the satellite 102 of the system 100 includes computing devices (e.g., a computing device as illustrated in FIG. 8). The satellite 102 includes hardware, firmware, and/or software configured to enable the satellite to send and receive data using multiple types of communication interfaces and/or protocols. Further, the satellites 102 select and interact with ground sinks and/or stations as described herein. Additionally, the satellite 102 includes hardware, firmware, and/or software configured to capture image data of the surface, to transform or otherwise process captured image data, and/or generate insight data from the captured image data as described herein.

In some examples, the ground IoT devices and stations or sinks 106-108 used are distributed across many locations on the Earth and they are designed to be low-cost devices. Further, in some examples, the system 100 includes a constellation of satellites 102 configured to provide wide coverage across the Earth, with major locations having coverage at nearly all times. The distribution of the described ground IoT devices and ground stations or sinks is configured in such a way as to provide that constellation of satellites 102 with a wide variety of communication targets as they orbit the globe, and to increase the frequency with which each ground IoT device 106 is enables to send image capture requests to satellites 102 as described herein.

In some examples, the satellites 102 of the system 100 are cube satellites or nanosatellites with Long Range (LoRa) gateway radio communication interfaces (e.g., capable of operating in Very High Frequency (VHF), Ultrahigh Frequency (UHF), and/or Industrial, Scientific, and Medical (ISM) frequency bands) for data communication and configuration and Narrow Band Internet of Things (NB-IoT) user equipment (UE) radio communication interfaces for configuration. In other examples, other specific communication interfaces and/or protocols are used without departing from the description. Further, in some examples, the satellites 102 include other equipment, such as a camera that captures images of the earth's surface, other sensors, or the like. The satellites operate in Low Earth Orbit (LEO). Additionally, or alternatively, due to the small size and low cost of the satellites 102, in some examples, they lack the capability to communicate with other satellites of the constellation directly.

In some examples, the ground IoT devices 106 include Internet of Things (IoT) modems that operate as narrow-band radios for sending data directly to satellites from the ground. In some examples, the IoT modems use LoRa transceivers for modulation and demodulation, enabling the modems to operate in multiple frequency bands, including VHF, UHF, and ISM (868 and 915). Thus, the IoT modems communicate with the satellites directly using the LoRa communication interfaces. In other examples, other types of protocols and/or communication interfaces are used between the ground IoT devices 106 and the satellites 102 without departing from the description.

Additionally, or alternatively, the ground IoT devices 106-108 include other computing devices and/or components (e.g., a modem is connected to an external computing device via Universal Serial Bus (USB) or Universal Asynchronous Receiver Transmitter (UART)). In some examples, the ground IoT devices 106-108 further include microcontrollers, single-board computers, or the like, as well as peripheral components such as sensors that collect data at the location of the ground IoT device 106. For instance, a ground IoT device 106 includes a sensor hub associated with a variety of sensors that collects and transmits sensor data to satellites 102 of the system 100. Additionally, the ground IoT devices 106 include other components, such as Global Positioning System (GPS) modules for geo-location.

The system includes ground IoT devices, ground stations or sinks 106-108, and/or other devices for sending data to and/or receiving data from the satellites over narrowband channels such as NB-IoT and LoRa network interfaces. Additionally, or alternatively, ground IoT devices 106-108 of the system 100 can be further configured to send image capture requests and/or other commands to the satellites 102 via those same channels or different channels. Further, ground IoT devices 106 send parameter data to the satellites 102, which is used by the satellites 102 to enable the satellites 102 to perform image capture operations and associated data processing operations, as described herein. In contrast, ground sinks 108 of the system only receive data from satellites 102 over narrowband channels and to not send data to the satellites 102 or otherwise perform uplink transmissions.

In some examples, the ground IoT devices, ground stations, and/or ground sinks are distributed across many different locations, and they are low-cost, enabling efficient establishment of a wide and varied network.

As illustrated, the ground IoT device 106 of the system 100 includes a communication interface 110. In some examples, the communication interface 110 includes hardware, firmware, and/or software configured to send data to and receive information from satellites 102 of the system. The communication interface 110 performs communication operations using at least one type of wireless communication protocol as described herein. Further, in some examples, the communication interface 110 performs secure communication operations such as encryption of the data being sent and/or decryption of data when it is received.

Further, in some examples, the ground IoT device 106 includes one or more sensors 112. The sensors 112 include hardware, firmware, and/or software configured to collect or otherwise obtain data indicative of physical features or states of a region in proximity to the ground IoT device 106. In some examples, the ground IoT device 106 includes a temperature sensor 112 that is used by the ground IoT device 106 to collect temperature data points indicative of the temperature of the environment in which the ground IoT device 106 is located. In other examples, more, fewer, or different types of sensors 112 are included in the ground IoT device 106 without departing from the description.

Additionally, or alternatively, the ground IoT device 106 is connected to or otherwise in communication with sensors 112 that are outside of the ground IoT device 106. In some examples, the ground IoT device 106 is connected to a plurality of different sensors that gather sensor data from a variety of different locations and provide the gathered sensor data to the ground IoT device 106. In some examples, the different sensors each collect the same type of data (e.g., a plurality of moisture sensors measure moisture levels in various locations of a region associated with the ground IoT device). Alternatively, or additionally, the plurality of different sensors collect different types of data (e.g., the plurality of sensors includes moisture sensors, temperatures sensors, barometric pressure sensors, or the like).

The ground IoT device 106 includes request trigger rules 114. In some examples, the ground IoT device 106 evaluates the request trigger rules 114 and, based on the evaluation indicating that a trigger event has occurred, to generate and send image capture requests to satellites 102 to capture one or more images as described herein. For example, an image capture request may specify an exact quantity, a minimum quantity, a maximum quantity, a range of quantities, or the like, to be captured. In some examples, sensor data values collected by sensors 112 are compared to threshold values of the request trigger rules 114 and, based on the sensor data values exceeding the threshold values or otherwise satisfying a requirement of one or more of the request trigger rules 114, the ground IoT device 106 generates an image capture request and sends the request to a satellite 102. In some examples, request trigger rules 114 include rules triggered by temperature measurements (e.g., monitoring freezing temperatures in farm fields), rules triggered by water level (e.g., monitoring for flood waters), rules triggered by smoke or particulates in the air (e.g., pollution monitoring or forest fire monitoring that could be monitored using temperature data combined with smoke or particulate data). In other examples, request trigger rules 114 are based on sensor data associated energy applications such as windmills, power grids, and/or oil and gas logistics. Still other examples include request trigger rules 114 that are based on transportation or maritime applications without departing from the description.

Further, in some examples, the request trigger rules 114 include single thresholds for comparison with sensor data values (e.g., an image capture request is triggered when temperature sensor data exceeds a defined threshold of a request trigger rule 114), multiple thresholds for comparison with sensor data values (e.g., an image capture request is triggered when temperature sensor data falls outside or inside of a defined threshold range of a request trigger rule 114), or the like. Additionally, or alternatively, in some examples, request trigger rules 114 are defined to be triggered based on sets of sensor data values and/or aggregated sensor data values. For instance, a request trigger rule 114 triggers an image capture request based on an average data value of collected data values from a time range (e.g., the past week, the past three days, or the like).

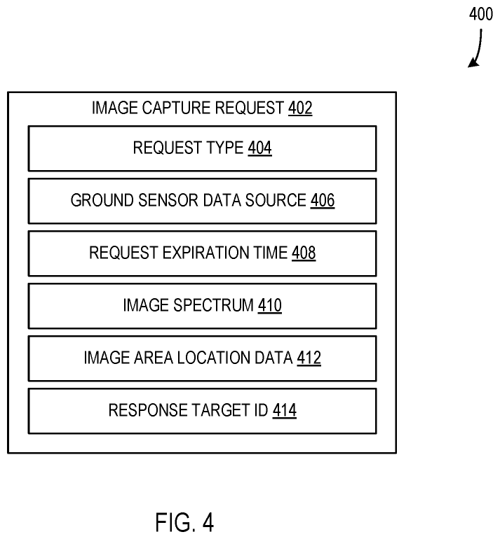

In some examples, the ground IoT device 106 generates and sends image capture requests to satellites 102 of the system. Image capture requests as generated by the ground IoT device 106 are described in greater detail below with respect to FIG. 4.

The satellite 102 of the system 100 includes an image data collector 116. In some examples, the image data collector 116 includes hardware, firmware, and/or software for capturing, collecting, or otherwise obtaining image data or optical data of the surface of the Earth or other target regions or locations. In some examples, the image data collector 116 includes one or more camera devices that use lenses and/or other optical data capture hardware, firmware, and/or software.

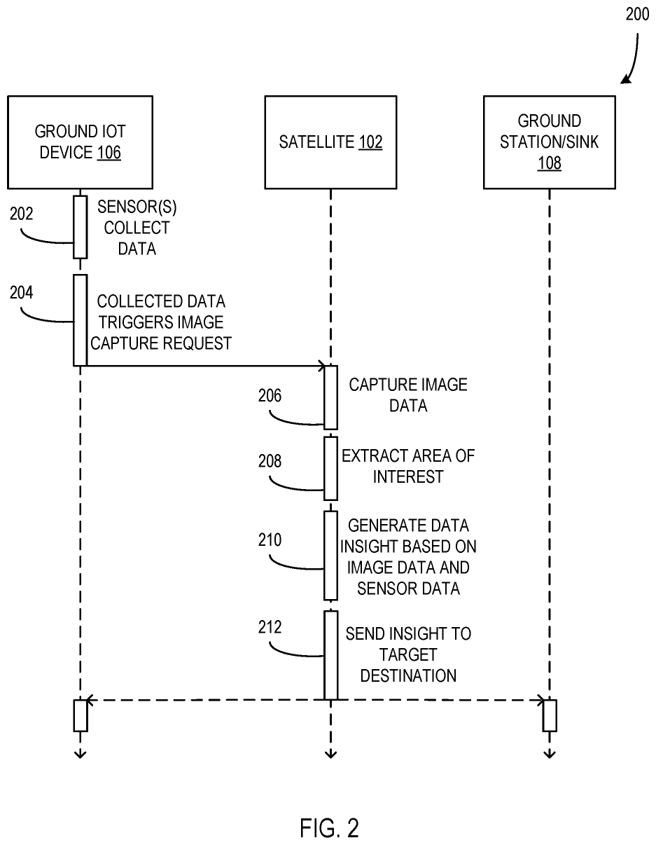

Further, in some examples, the image data collector 116 captures data from one or more different electromagnetic spectrum ranges (e.g., visible light spectrum, infrared light spectrum, ultraviolet light spectrum, or the like). Additionally, or alternatively, the image data collector 116 captures various types of data (e.g., black and white image data, red-green-blue (RGB) data, multi-spectral data, thermal data, or filtered image data). In such examples, the system 100 includes a plurality of satellites 102 and each satellite 102 of the plurality of satellites 102 includes an image data collector 116 to collect a single type or otherwise limited types of optical data (e.g., one satellite 102 captures optical data in the visible light spectrum and another satellite 102 captures optical data in the infrared light spectrum). In some examples, the ground IoT devices 106 of the system 100 include a requested optical data type. The satellites 102 with limited optical data capture capabilities use the requested optical data type to filter received requests for fulfillment. This process is described in greater detail below with respect to FIG. 2.

While some examples are described with respect to the image data collector 116, the satellite 102 may be outfitted with a data collector other than the image data collector 116. For example, the satellite 102 may have scientific instruments capable of making other measurements such as measurements of radiation, gases, and temperature.

The satellite 102 includes an image data store 118 and a sensor data store 120. In some examples, the image data store 118 is used to store data captured by the image data collector 116 and the sensor data store 120 is used to store sensor data received by the satellite 102 from ground IoT devices 106 in image capture requests. In such examples, the data stores 118 and/or 120 store data of the associated data types throughout the operation of the satellite (e.g., the processes of analyzing captured image data and/or sensor data and generating responses to image capture requests as described herein).

The satellite 102 includes a data insight generator 122. In some examples, the data insight generator 122 includes hardware, firmware, and/or software configured for performing analysis of captured image data and/or received sensor data to generate insight data that is provided to ground IoT devices 106 or ground stations or sinks 108 in response to image capture requests. The operations of the data insight generator 122 are described in greater detail below with respect to FIG. 2.

As illustrated, the satellite 102 of the system 100 includes a communication interface 124. In some examples, the communication interface 124 includes hardware, firmware, and/or software configured to send data to and receive information from ground IoT devices, stations, or sinks 106-108 of the system 100. The communication interface 124 performs communication operations using at least one type of wireless communication protocol as described herein. Further, in some examples, the communication interface 124 performs secure communication operations such as encryption of the data being sent and/or decryption of data when it is received. It should be understood that, in some examples, the communication interface 124 operates in a compatible manner with respect to the communication interface 110 of the ground IoT device 106 such that the interfaces 124 and 110 enable the respective entities to communicate with each other.

FIG. 2 is a sequence diagram illustrating a process 200 of capturing image data by a satellite 102 based on an image capture request from a ground IoT device 106. In some examples, the process 200 is executed or otherwise performed by entities of a system such as system 100 of FIG. 1. At 202, the sensors (e.g., sensors 112) of the ground IoT device 106 collect data. In some examples, the collection of data by the sensors of the ground IoT device 106 occurs repeatedly over time. In some examples, the sensors collect data constantly over time, at regular intervals, and/or in response to being triggered by the ground IoT device 106.

At 204, the collected data triggers an image capture request to be generated and sent to a satellite 102 by the ground IoT device 106. In some examples, the collected data triggers the image capture request based on the evaluation of one or more request trigger rules 114 of the ground IoT device 106 as described herein. Further, in some examples, the ground IoT device 106 continues collecting data with sensors at 202 during and/or after the image capture request is triggered, such that the collection of sensor data is performed consistently throughout the process 200.

Further, in some examples, the ground IoT device 106 sends the image capture request to a satellite 102 based on stored data indicating the presence of the satellite 102 in proximity to the ground IoT device 106 (e.g., two-line element (TLE) data indicative of the orbit shape and location of the satellite 102). Additionally, or alternatively, the ground IoT device 106 sends the image capture request to multiple satellites 102 that are in proximity to the ground IoT device 106 increase the likelihood that the requested image data is captured within a short time (e.g., each satellite 102 has a limited time during which the target location image data can be captured).

At 206, the satellite 102 receives the image capture request from the ground IoT device 106 and the satellite 102 captures image data based on the request. In some examples, the request includes information that indicates a target location for the image to be captured and the satellite 102 uses the information to target its image data collector 116 or other similar components. In some examples, the target location information indicates a location using latitude and longitude values and/or data indicating the size and/or shape of the requested image (e.g., a specific point indicated by latitude and longitude values and a radius value indicating the size of the circular image to be captured).

At 208, the satellite 102 extracts the area of interest (AoI) from the captured image data based on the image capture request. In some examples, the image capture request includes data indicating a specific subset of the captured image data that will be used for further data processing. The image data of this AoI is extracted from the larger captured image data such that a more precise set of AoI image data remains for further processing. For instance, image data of a particular farm field is extracted from captured image data of several different fields. The AoI includes any size or shape of geographical area or region, within the limits of the image capture ability of the satellite 102.

At 210, the extracted AoI image data and sensor data included in the image capture request are used to generate a data insight. In some examples, generating the data insight includes overlaying sensor data on the image data, interpolating and/or extrapolating sensor data throughout the AoI image data region, or the like. Further, in some examples, the data insight includes representing the sensor data and associated generated data points on the AoI image data using colors, patterns, and/or symbols (e.g., a heatmap indicating different sensor data value levels through different color patterns on the image data region). As such, the data insight may include a numerical value, text, an image, or other data corresponding to the extracted AoI image data and/or sensor data. In some examples, the extracted AoI image data and/or sensor data is transformed into the data insight. The data insight is then consumed by an end user, administrator, process, or application, which takes action based on the data insight. The action includes, for example, remedial action, proactive action, or reactive action.

At 212, the satellite 102 sends the generated insight to a target destination. In some examples, the target destination is the ground IoT device 106 from which the image capture request was sent. Alternatively, or additionally, the target destination is a ground station or sink 108 (or other ground device). In some examples, a plurality of ground IoT devices with sensors are deployed throughout a region and a single ground sink is deployed for receiving all image data and/or data insights associated with the plurality of ground IoT devices.

Some examples are described with reference to the satellite 102 generating the data insights in real-time. In other examples, the operations described as being performed by the satellite 102 are performed by other servers. Such examples provide data insights not in real-time, but are generated and provided offline.

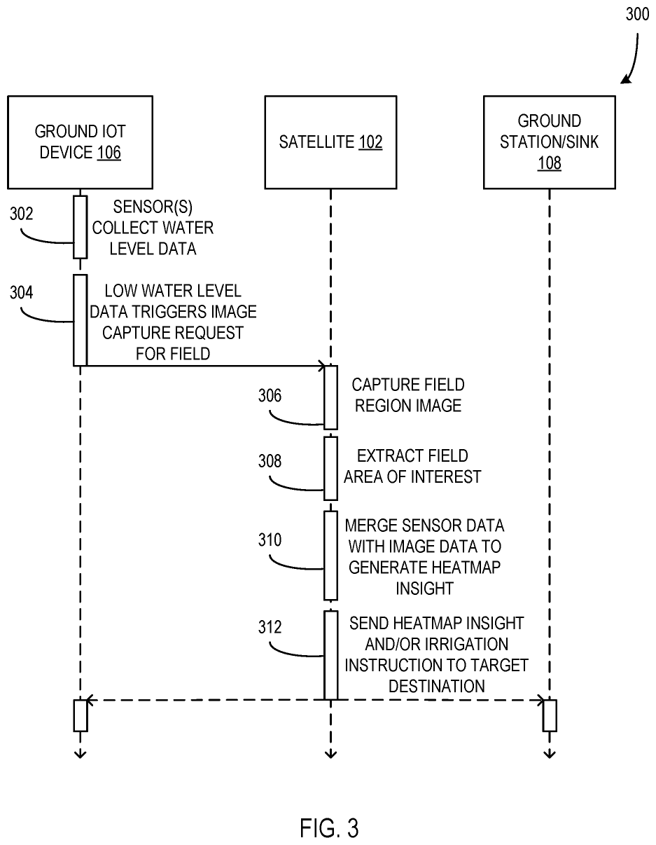

FIG. 3 is a sequence diagram illustrating a process 300 of capturing image data of a field by a satellite 102 based on an image capture request from a ground IoT device 106 associated with collected water level sensor data. In some examples, the process 300 is executed or otherwise performed by a system such as system 100 of FIG. 1. Further, it should be understood that process 300 is a specific implementation of the process 200 described above and, in some examples, the process 300 is performed in substantially the same way as process 200. At 302, the ground IoT device 106 collects water level data using sensors (e.g., sensors 112). In some examples, the sensors of the ground IoT device 106 collect water level data at the location of the ground IoT device 106. Alternatively, or additionally, sensors located throughout an area in proximity to the ground IoT device 106 collect water level data at points throughout the area and send the water level data to the ground IoT device 106.

At 304, low water level data triggers an image capture request for a field with which the ground IoT device 106 is associated. In some examples, low water level data values are used to evaluate a request trigger rule 114 of the ground IoT device and, based on those low water level data values falling below a threshold of that rule, the image capture request is generated and sent to the satellite 102.

At 306, the satellite 102 captures an image of the field region and, at 308, the AoI that includes the field is extracted from the captured image. In some examples, the AoI image is extracted based on data indicative of the boundaries of the field provided in the image capture request. In some examples, the AoI image is shaped as a rectangle or other similar polygonal shape associated with the boundaries of the field.

At 310, the sensor data is merged with the AoI image data to generate a heatmap insight of the field, wherein the different patterns of colors of the heatmap are indicative of water levels throughout the field. In some examples, the color patterns of the heatmap are based on interpolated and/or extrapolated water level values that are generated based on the sensor data values and locations of sparse sensors within or near the field.

At 312, the heatmap insight and/or irrigation instructions are sent to the target destination (e.g., the ground IoT device 106 and/or a different target such as ground station or sink 108). In examples where irrigation instructions are sent, the satellite 102 generates irrigation instructions based on the generated heatmap insight, such that areas within the field that have lower water levels based on the heatmap are provided with more water via the irrigation instructions than areas within the field that have higher water levels. In other examples, other types of insights and/or instructions are generated by the satellite 102 without departing from the description.

FIG. 4 is a diagram illustrating a structure 400 of an image capture request 402 from a ground IoT device (e.g., ground IoT device 106). In some examples, the image capture request 402 is generated and sent by a ground IoT device 106 to a satellite 102 in a system such as system 100 of FIG. 1.

The image capture request 402 includes a request type 404. The request type 404 includes data that is indicative of a type of action or operation being requested of the satellite 102 that receives the request 402. In some examples, the request type 404 includes at least one of type data indicating a request for image capture and visual analysis. The type data indicates a request for image capture and sensor data fusion, and/or indicates a request for image capture and delivery of the captured image to a target destination (e.g., the ground IoT device 106 from which the request 402 originated). In other examples, other types of request type data are included in the request type 404 of a request 402 without departing from the description.

The image capture request 402 includes a ground sensor data source 406. The ground sensor data source 406 includes data indicating the device or devices from which sensor data is to be received or obtained by the satellite 102. In some examples, the ground sensor data source 406 is the ground IoT device 106 that sent the request 402. In such examples, the ground sensor data source 406 includes an identifier of the ground IoT device 106 and/or the sensor data for use by the satellite 102. Alternatively, or additionally, the ground sensor data source 406 includes data indicating that sensor data is to be obtained or received from one or more other devices. In such examples, the satellite 102 communicates with the one or more other devices to obtain the sensor data as indicated in the request 402. Further, in some examples, the satellite 102 has already received some or all of the sensor data associated with the request 402 and, upon receiving the request 402, the satellite 102 accesses the received data based on the ground sensor data source 406, which can be used by the satellite 102 to identify the stored data with which the request 402 is associated.

In some examples, the ground sensor data source 406 of the request 402 is populated only when the request type indicates that sensor data is to be fused with the image data. In requests 402 of other types, the ground sensor data source 406 is empty or otherwise not present in the request 402.

Additionally, or alternatively, the satellite 102 includes a predefined list of devices that can be identified in the ground sensor data source 406 field such that the satellite 102 is enabled to communicate with those devices upon receiving a request 402. In other examples, the satellite 102 searches for the type of data from other sensor devices in proximity to the source of the request 402 and/or within, or in proximity to, the target location of the request 402.

The image capture request 402 includes a request expiration time 408. In some examples, the request expiration time 408 includes data indicative of a time by which a response should be provided to the request 402. The request expiration time 408 can be used by the satellite 102 to generate a priority order for handling the request 402 and other requests it receives, as described herein.

The image capture request 402 includes an image spectrum 410. In some examples, the image spectrum 410 includes data that indicates the spectrum of the image data being requested (e.g., visual light spectrum, infrared light spectrum, ultraviolet light spectrum, or the like). In such examples, the satellite 102 is enabled to determine whether the request 402 can be fulfilled based on the image capture capabilities of the satellite 102. For instance, if the request 402 requires image data in the infrared light spectrum and the satellite 102 does not have infrared light spectrum capture capabilities, the satellite 102 can determine that it cannot fulfill the request 402. Alternatively, if the satellite does have infrared light spectrum capture capabilities, the satellite 102 can determine that it is capable of fulfilling the request 402.

The image capture request 402 includes image area location data 412. In some examples, the image area location data 412 is indicative of the area for which image data is to be captured. The image area location data 412 includes data indicating the location and/or dimensions of an AoI with respect to the location of the ground IoT device 106 that sent the request or data indicating location of the AoI independent of the location of the ground IoT device 106 (e.g., latitude and longitude data). Further, in some examples, the image area location data 412 includes data indicative of the shape of the AoI, the borders of the AoI, and/or other features of the AoI that can be used by the satellite 102 when capturing image data for responding to the request 402 as described herein.

In some examples, the image area location data 412 is predefined by a user or dynamically generated (e.g., driven by machine intelligence).

The image capture request 402 includes a response target ID 414. In some examples, the response target ID 414 includes data that identifies at least one device to which the response to the request 402 is to be sent. Additionally, or alternatively, the response target ID 414 includes identifiers of a plurality of response targets, such that the satellite 102 is enabled to send a response to one or more of the included identifiers (e.g., the satellite 102 is required to send a response to one of the response targets or it is required to send a response to more than one of the response targets). As described previously, the response target ID 414 identifies the ground IoT device 106 that sent the request 402 and/or other devices such as ground IoT devices or ground sinks (e.g., ground station or sink 108).

Below is a pseudocode Example 1 of an exemplary request handling process of a satellite 102.

### PROCESS EXAMPLE 1

### Handling Image Capture Request

| | |
|---|---|
| 1 | while true do |
| | { |
| 2 | POP request FROM requestPriorityQueue; |
| 3 | GET listOfRequestors and listOfDestinations FROM |
| | Check_and_Drop_Duplicate_Request(requestPriorityQueue, |
| | request); |
| 4 | GET isRequestServiceable and reasonCode FROM |
| | Check_Request_Serviceable(request); |
| 5 | if isRequestServiceable == false then |
| | { |
| 6 | Notify_Request_Status(reasonCode, listOfRequestors); |
| 7 | CONTINUE; |
| | } |
| 8 | else |
| | { |
| 9 | GET initialAoI FROM Generate_AoI_Circular( |
| | listOfRequestors, request.areaSize); |
| 10 | if request.type == sensorFusion then |
| | { |
| 11 | if request.source.type == neighborSensors then |
| | { |
| 12 | GET sensorData[ ] FROM Aggregate_Sensor_Data( |
| | request.source.type, initialAoI, |
| | request.expiration); |
| 13 | if sensorData == null then |
| | { |
| 14 | SET reasonCode TO noSensorData; |
| 15 | Notify_Request_Status(reasonCode, |
| | listOfRequestors); |
| 16 | CONTINUE; |
| | } |
| 17 | end |
| | } |
| 18 | else |
| | { |
| 19 | GET sensorData[ ] FROM Get_Data_From_Local |
| | (request.requestorAddress); |
| | } |
| 20 | end |
| | } |
| 21 | end |
| 22 | GET image FROM Get_Image(initialAoI, request.imageType); |
| 23 | GET polygonAOI FROM Generate_AoI_Polygon (image, |
| | initialAoI); |
| 24 | if request.type == sensorFusion then |
| | { |
| 25 | GET results FROM Execute_Fusion(polygonAoI, |
| | sensorData[ ], request.insightType); |
| | } |
| 26 | else |
| | { |
| 27 | GET results FROM Generate_Insight_From_Image( |
| | polygonAoI, request.insightType); |
| | } |
| 28 | end |
| 29 | Deliver_Results_Downlink(listOfDestinations, results); |
| | } |
| 30 | end |
| | } |
| 31 | end |

In some examples, the process described in process Example 1 above is executed or otherwise performed by a satellite 102 in a system such as system 100 of FIG. 1. The process includes a ‘while’ loop at line 1, such that the process is performed repeatedly during operation of the satellite 102. At line 2, a request (e.g., an image capture request 402 as described herein) is ‘popped’ or otherwise obtained from a requestPriorityQueue data structure. In some examples, the requestPriorityQueue stores a plurality of requests that have been received by the satellite 102. Further, the order of the requests in the queue is based on relative priorities of the requests there. In some examples, the requests are ordered based on remaining time until expiration, such that requests with shorter times until expiration are prioritized over requests with relatively longer times until expiration. In some examples, the ‘POP’ function obtains the highest priority request from the queue for processing, removing that request from the queue.

At line 3 a ‘listOfRequestors’ and ‘listOfDestinations’ is obtained from a ‘Check_and_Drop_Duplicate_Request’ function. In some examples, this function compares the obtained requests to other requests in the requestPriorityQueue and, upon identifying duplicate requests therein, the duplicate requests are also removed from the queue. The function also returns a ‘listOfRequestors’ data structure including identifiers of entities (e.g., ground IoT devices 106) that sent the request and any identified duplicate requests and a ‘listOfDestinations’ data structure including identifiers of the target destinations of the request and any identified duplicate requests. These data structures enable the satellite 102 to completely process the request and ensure that all target destinations are provided with a response to the requests.

In some examples, the same request arrives from multiple nearby ground IoT devices that are triggered by the same or similar events in the region. Some examples include soil moisture monitoring of a farm, flood monitoring, forest fire detection, and the like. Duplicate requests are identified in the requestPriorityQueue based on at least one of a request type, an AoI of the request, a sensor data type and/or source, a difference in request expiration time, or the like. In such examples, the process processes such duplicate requests only once, but to preserve the lists of requestors and destinations of all duplicate requests so the satellite can provide each target destination with the results.

At line 4, an ‘isRequestServiceable’ indicator and a ‘reasonCode’ value are obtained from a ‘Check_Request_Serviceable’ function. In some examples, the function checks that the satellite is capable of servicing the request. In some examples, the function compares an image spectrum requirement (e.g., image spectrum 410) of the request to the image spectrum capture capabilities of the satellite and returns an indicator that indicates whether the satellite is capable of capturing an image in the requested spectrum. In other examples, other request requirements are compared to capabilities and/or configuration details of the satellite to generate the ‘isRequestServiceable’ indicator (e.g., the computation capability of the satellite should be sufficient to complete the request processing within the expiration time of the request and/or the satellite should have available downlink capability and bandwidth for delivering the results to the target destinations). The ‘reasonCode’ value is generated to indicate a specific reason why the request is or is not serviceable by the satellite.

At line 5, if the request is not serviceable, the process proceeds to lines 6 and 7, where the requestors of the ‘listOfRequestors’ are notified of the reason that the request cannot be processed using the ‘reasonCode’ and a ‘Notify_Request_Status’ function. In some examples, the requestors then retry the request with another satellite that becomes available. At line 7, the process returns to the beginning of the while loop based on the ‘Continue’ function, such that the next request is obtained from the ‘requestPriorityQueue’.

Alternatively, if the request is serviceable by the satellite, the process enters the ‘else’ statement at line 8 and proceeds to line 9. At line 9, an ‘initialAoI’ data structure is obtained from a ‘Generate_AoI_Circular’ function based on the ‘listOfRequestors’ and an area size value of the request. In some examples, the ‘initialAoI’ data structure includes location data, size data, and/or shape data (e.g., a circle with a defined radius) of the AoI of the request (e.g., the area to be captured in image data by the satellite as described herein). This data structure is used by the satellite in the process of capturing the image data as described below. Further, in some examples, identified duplicate requests have differing AoIs and those differing AoIs are merged into an expanded AoI for use during the described request processing. The initial circular AoI enables the satellite to identify sensor data sources and extract a proper region from captured image data in later steps.

At line 10, if the request type is ‘sensorFusion’, indicating that the captured image data is to be combined with sensor data from the requesting entities or other associated sensors, the process proceeds to line 11. Alternatively, if the request type is not ‘sensorFusion’ the process proceeds to line 22.

At line 11, if the source type of the sensor data is ‘neighborSensors’, indicating the sensor data sources are other devices than the requestors, the process proceeds to line 12. Alternatively, if the source of the sensor data is the requesting device or devices, the process proceeds to line 19.

At line 12, sensor data is obtained in a ‘sensorData[]’ data structure from an ‘Aggregate_Sensor_Data’ function based on the source type of the request, the ‘initialAoI’ structure, and the request expiration time. At line 13, if the sensorData data structure is empty, the process proceeds to line 14. Alternatively, if the sensorData data structure is not empty, the process proceeds to line 22.

Further, in some examples, the aggregation of sensor data from nearby sensor devices is based on static mapping of the sensor data sources and, in other example, it is based on dynamic mapping of sensor data sources. In some examples including static mapping, the requestor is part of a private network of sensor devices that are statically mapped and that data is provided to the satellite for use in collecting sensor data from those sensor devices. For example, a farm includes IoT devices throughout a field connected on a private network. The owner of the farm statically maps those IoT devices for use in providing sensor data to satellites as described herein. Alternatively, in some examples including dynamic mapping, the satellite dynamically identifies sensor devices that have the requested type of sensor in and/or near the AoI of the request (e.g., via a public network).

In such examples, when the sensor devices are identified, the satellite checks local storage for existing data from those sensor devices and, if existing data is not found for some of the sensor devices, the satellite uses a multicast request to the devices for pulling the sensor data. Additionally, or alternatively, the satellite uses a timer-based cancellation method such that the process returns to the caller when the timer is triggered, and the timer is set in coordination with the expiration of the request.

At line 14, the sensorData structure is empty (e.g., the sensor aggregation function timed out) and the reasonCode value is set to ‘noSensorData’ and the requestors are notified of the reason that processing the request failed at line 15 as described above with respect to line 6.

At line 19, when the source of the sensor data is not neighbor sensors, a ‘sensorData[]’ data structure is generated from a ‘Get_Data_From_Local’ function that uses the requestor address of the request.

At line 22, an ‘image’ data structure is obtained from a ‘Get_Image’ function based on the initialAoI data structure (e.g., the circular AoI that was initially generated) and an image type of the request (e.g., the requested spectrum type). In some examples, the image data structure includes captured optical image data and/or other data associated with the capture of the image data.

At line 23, a ‘polygonAoI’ data structure is obtained from a ‘Generate_AoI_Polygon’ function based on the image data structure and the initialAoI data structure. In some examples, the polygonAoI data structure includes a polygon shape that is created as a best fit on the initial circular AoI generated previously. In such examples, the initial circular AoI is a calculated area but is not used in image extraction or fusion.

At line 24, if the request type is ‘sensorFusion’, the process proceeds to line 25. Alternatively, if the request type is not ‘sensorFusion’, the process proceeds to line 27.

At line 25, a ‘results’ data structure is generated from an ‘Execute_Fusion’ function based on the polygonAoI structure, the sensorData[] structure, and the insight type of the request. In some examples, the extracted polygon region of the polygonAoI is merged with the collected sensor data from the sources. Additionally, or alternatively, the results of the fusion process are generated based on the insight requested in the request (e.g., a heatmap, a vegetation index map, or the like).

At line 27, a ‘results’ data structure is generated from a ‘Generate_Insight_From_Image’ function based on the polygonAoI structure and the insight type of the request. In examples where only the captured image is requested, the extracted polygonal AoI is used as the results data structure.

At line 29, the results data structure is provided to destinations using a ‘Deliver_Results_Downlink’ function based on the listOfDestinations structure and the results structure. In some examples, the results data structure is stored in a local queue until it can be delivered to each target destination.

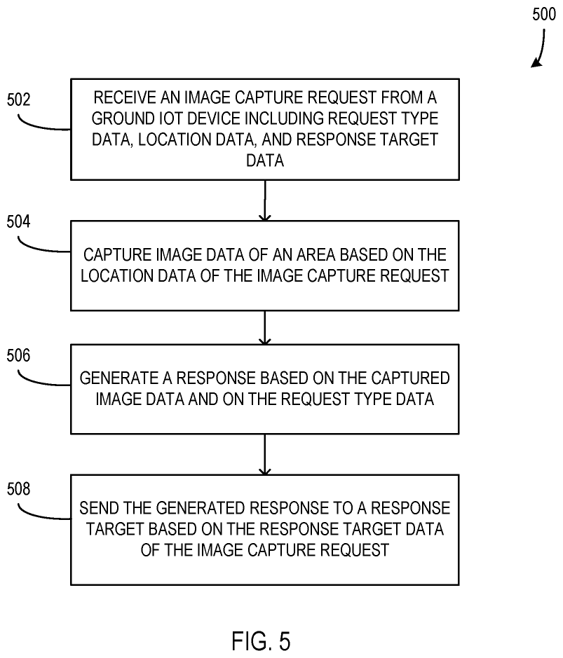

FIG. 5 is a flowchart illustrating a method 500 for processing and responding to an image capture request by a satellite. In some examples, the method 500 is executed or otherwise performed by a satellite such as satellite 102 of system 100 in FIG. 1. At 502, an image capture request is received from a ground IoT device. The request includes request type data, location data, and response target data. In some examples, the request includes other types of data as well, such as the types of data described above with respect to FIG. 4.

At 504, image data of an area is captured based on the location data of the image capture request. The image data is captured by the satellite using an image capture device of the satellite. In some examples, the satellite captures the image data in a defined spectrum based on image spectrum data included in the request.

At 506, a response is generated based on the captured image data and on the request type data of the request. In some examples, the response includes the captured image data. Further, in some examples, the response includes response data based on sensor data and/or insights generated therefrom as described herein.

At 508, the generated response is sent to a response target based on the response target data of the image capture request. In some examples, the response target is the ground IoT device that sent the image capture request. Additionally, or alternatively, the response target of the response includes one or more other devices, such as other ground IoT devices, ground stations, or ground sinks as described herein.

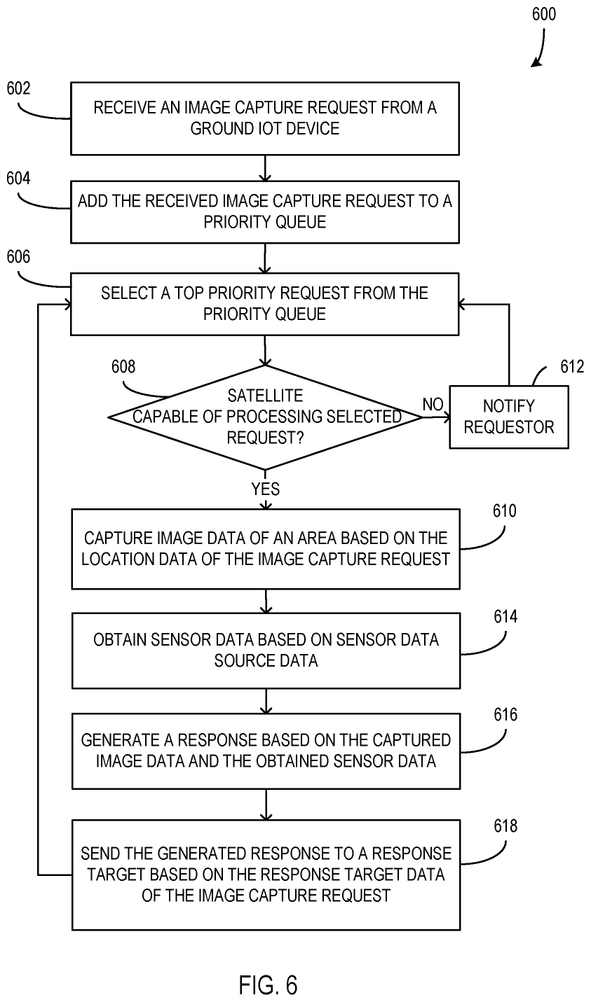

FIG. 6 is a flowchart illustrating a method for processing and responding to image capture requests based on captured image data and associated sensor data. In some examples, the method 600 is executed or otherwise performed by a satellite such as satellite 102 of system 100 in FIG. 1. At 602, an image capture request is received from a ground IoT device and, at 604, the received image capture request is added to a priority queue. In some examples, the image capture request includes expiration time data that is used to prioritize the request with respect to other requests in the queue as described herein. Further, it should be understood that, during the performance of the method 600, when other image capture requests are received by the satellite, they also are added to the priority queue at 604 as described herein.

At 606, a top priority request is selected from the priority queue. In some examples, selecting the top priority request includes removing the request from the priority queue such that another request becomes the top priority request. Further, in some examples, selecting the top priority request from the priority queue includes identifying duplicate requests in the priority queue and removing those duplicate requests from the priority queue as described herein.

At 608, if the satellite is capable of processing the selected request, the process proceeds to 610. Alternatively, if the satellite is not capable of processing the selected request, the process proceeds to 612. In some examples, the capability of the satellite is determined based on the types of spectrums in which the satellite can capture images. For instance, if the request requires capture of an image using the infrared spectrum and the satellite is not capable of capturing images using the infrared spectrum, then the satellite is not capable of processing the request.

At 610, image data of an area is captured based on location data of the image capture request. In some examples, capturing the image data of the area is performed in substantially the same way as described above with respect to 504 of FIG. 5. Then, the process proceeds to 614.

Alternatively, at 612, the requestor of the image capture request that the satellite cannot process is notified that the request will not be fulfilled by the satellite. After the notification is sent, the process returns to 606 to select another top priority request from the priority queue.

At 614, sensor data is obtained based on sensor data source data (e.g., data that includes identifiers of sensor data sources) of the image capture request. In some examples, the sensor data is obtained from the source of the request, either in the request itself or based on the satellite requesting sensor data therefrom. Alternatively, or additionally, the sensor data is obtained from one or more other devices, such as ground IoT devices with associated sensor devices. In some examples, the satellite requests the sensor data from those other devices based on the locations of those other devices within or in proximity to the AoI of the request, as described herein.

At 616, a response is generated based on the captured image data and the obtained sensor data. In some examples, the obtained sensor data and captured image data are combined into a sensor data image map (e.g., a heatmap indicative of sensor data values in the region with which the image data is associated). Further, the combination of the sensor data and image data includes extrapolating and/or interpolating data values throughout the AoI of the image data based on the obtained sensor data values. Additionally, or alternatively, insights are generated from the image data and/or the sensor data and included in the generated response (e.g., irrigation instructions generated based on water level data in a field and sent to devices to control irrigation of the field).

At 618, the generated response is sent to a response target based on the response target data of the image capture request. In some examples, the sending of the response to a response target is performed in substantially the same way as described above with respect to 508 of FIG. 5.

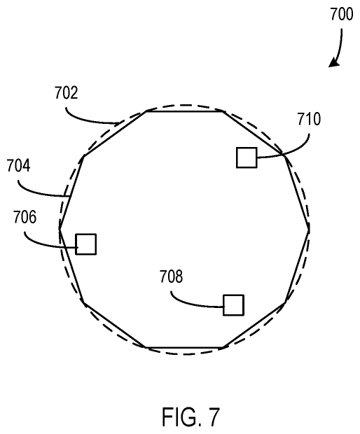

FIG. 7 is a diagram 700 illustrating an initial circular AoI 702, an associated polygonal AoI 704, and sensor devices 706, 708, and 710 associated with the AoI. In some examples, circular AoI 702 and polygonal AoI 704 are generated and used by a satellite such as satellite 102 in system 100. As described herein, the satellite calculates the circular AoI 702 based on location data included in an image capture request. In some examples, the satellite 102 captures image data of the surface based at least in part on the location data and the calculated circular AoI 702.

In some examples, the polygonal AoI 704 is generated from the circular AoI 702 using a best fit technique. The polygonal AoI 704 is used to extract the AoI image data from a larger set of captured image data. Further, the AoI's 702 and 704 include a plurality of sensor devices 706-710 from which sensor data is obtained. The satellite uses that sensor data in combination with the captured image data to generate combined image-sensor data and/or insights associated therewith, as described herein.

### Exemplary Operating Environment

The present disclosure is operable with a computing apparatus according to an embodiment as a functional block diagram 800 in FIG. 8. In an example, components of a computing apparatus 818 are implemented as a part of an electronic device according to one or more embodiments described in this specification. The computing apparatus 818 comprises one or more processors 819 which may be microprocessors, controllers, or any other suitable type of processors for processing computer executable instructions to control the operation of the electronic device. Alternatively, or in addition, the processor 819 is any technology capable of executing logic or instructions, such as a hardcoded machine. In some examples, platform software comprising an operating system 820 or any other suitable platform software is provided on the apparatus 818 to enable application software 821 to be executed on the device. In some examples, the generation and sending of image capture requests by ground IoT devices and the reception and processing of the requests by satellites as described herein is accomplished by software, hardware, and/or firmware.

In some examples, computer executable instructions are provided using any computer-readable media that are accessible by the computing apparatus 818. Computer-readable media include, for example, computer storage media such as a memory 822 and communications media. Computer storage media, such as a memory 822, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 822) is shown within the computing apparatus 818, it will be appreciated by a person skilled in the art, that, in some examples, the storage is distributed or located remotely and accessed via a network or other communication link (e.g., using a communication interface 823).

Further, in some examples, the computing apparatus 818 comprises an input/output controller 824 configured to output information to one or more output devices 825, for example a display or a speaker, which are separate from or integral to the electronic device. Additionally, or alternatively, the input/output controller 824 is configured to receive and process an input from one or more input devices 826, for example, a keyboard, a microphone, or a touchpad. In one example, the output device 825 also acts as the input device. An example of such a device is a touch sensitive display. The input/output controller 824 may also output data to devices other than the output device, e.g., a locally connected printing device. In some examples, a user provides input to the input device(s) 826 and/or receive output from the output device(s) 825.

The functionality described herein can be performed, at least in part, by one or more hardware logic components. According to an embodiment, the computing apparatus 818 is configured by the program code when executed by the processor 819 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: at least one processor of a satellite; and at least one memory comprising computer program code, the at least one memory and the computer program code configured to, with the at least one processor, cause the at least one processor to: receive an image capture request from a ground IoT device, the request including request type data, location data, and response target data, wherein the request type data is indicative of a sensor event at the ground IoT device; capture, using an image capture device of the satellite, image data of an area based on the location data of the image capture request; generate a response based on the captured image data and on the request type data; and send the generated response to a response target based on the response target data of the image capture request.

An example computerized method comprises: receiving, by a processor of a satellite, an image capture request from a ground IoT device, the request including request type data, location data, and response target data, wherein the request type data is indicative of a sensor event at the ground IoT device; capturing, by the processor, using an image capture device of the satellite, image data of an area based on the location data of the image capture request; generating, by the processor, a response based on the captured image data and on the request type data; and sending, by the processor, the generated response to a response target based on the response target data of the image capture request.

One or more computer storage media have computer-executable instructions that, upon execution by a processor, cause the processor to at least: receive an image capture request from a ground IoT device, the request including request type data, location data, and response target data, wherein the request type data is indicative of a sensor event at the ground IoT device; capture, using an image capture device of the satellite, image data of an area based on the location data of the image capture request; generate a response based on the captured image data and on the request type data; and send the generated response to a response target based on the response target data of the image capture request.

Alternatively, or in addition to the other examples described herein, examples include any combination of the following:
wherein the received image capture request includes sensor data source data; wherein the request type data includes a sensor data fusion indicator; wherein generating the response further includes: obtaining sensor data based on the sensor data source data of the image capture request; combining the obtained sensor data and the captured image data into a sensor data image map based on the sensor data fusion indicator; and including the sensor data image map in the generated response.
wherein the request type data includes a data insight request indicator; wherein generating the response further includes: generating a data insight from at least one of the obtained sensor data and the captured image data based on the data insight request indicator; and including the generated data insight in the generated response.
wherein obtaining the sensor data further includes: identifying a plurality of sensor devices based on the sensor data source data, wherein the plurality of sensor devices are located in proximity to the area associated with the location data; requesting sensor data from the identified plurality of sensor devices; and receiving the requested sensor data.
further comprising: adding the received image capture request to a priority queue based on receiving the image capture request, wherein a priority rank of the received image capture request in the priority queue is set based on an expiration time data value included in the received image capture request; and wherein capturing the image data of the area is based on the received image capture request becoming a top priority rank in the priority queue.
further comprising: based on the received image capture request becoming the top priority rank in the priority queue, identifying duplicate requests of the received image capture request in the priority queue; and removing the identified duplicate requests from the priority queue.
further comprising: identifying an image spectrum requirement of the received image capture request based on image spectrum data included in the received image capture request; based on the image capture device of the satellite failing to satisfy the identified image spectrum requirement, sending a notification to the ground IoT device, wherein the notification indicates that the satellite cannot process the image capture request; and wherein capturing the image data of the area is further based on the image capture device of the satellite satisfying the identified image spectrum requirement.
wherein the response target includes at least one of the following: the ground IoT device, another ground IoT device, and a ground station associated with the ground IoT device.

Any range or device value given herein may be extended or altered without losing the effect sought, as will be apparent to the skilled person.

Examples may have been described with reference to data monitored and/or collected from the users. In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for receiving, by a processor of a satellite, an image capture request from a ground IoT device, the request including request type data, location data, and response target data, wherein the request type data is indicative of a sensor event at the ground IoT device; exemplary means for capturing, by the processor, using an image capture device of the satellite, image data of an area based on the location data of the image capture request; exemplary means for generating, by the processor, a response based on the captured image data and on the request type data; and exemplary means for sending, by the processor, the generated response to a response target based on the response target data of the image capture request.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
at least one image capture device of a satellite;
at least one processor of the satellite; and
at least one memory comprising computer program code, the at least one memory and the computer program code configured to, with the at least one processor, cause the at least one processor to:
receive an image capture request from a ground Internet-of-Things (IoT) device, the request including request type data, location data, and response target data, wherein the request type data is indicative of a sensor event at the ground IoT device;
capture, using the image capture device of the satellite, image data of an area based on the location data of the image capture request;
generate a response based on the captured image data and the request type data; and
send the generated response to a response target based on the response target data of the image capture request.

2. The system of claim 1, wherein the received image capture request further includes sensor data, and wherein generating the response further includes:
combining the sensor data and the captured image data into a sensor data image; and
including the sensor data image in the generated response.

3. The system of claim 2, wherein the request type data includes a data insight request indicator;
wherein generating the response further includes:
generating a data insight from at least one of the sensor data and the captured image data based on the data insight request indicator; and
including the generated data insight in the generated response.

4. The system of claim 2, wherein obtaining the sensor data further includes:
identifying a plurality of sensor devices based on sensor data source data, wherein the plurality of sensor devices are located in proximity to the area associated with the location data;
requesting the sensor data from the identified plurality of sensor devices; and
receiving the requested sensor data.

5. The system of claim 1, wherein the at least one memory and the computer program code are configured to, with the at least one processor, cause the at least one processor to:
add the received image capture request to a priority queue based on receiving the image capture request, wherein a priority rank of the received image capture request in the priority queue is set based on an expiration time data value included in the received image capture request; and
wherein capturing the image data of the area is initiated based on a position of the received image capture request in the priority queue.

6. The system of claim 5, wherein the at least one memory and the computer program code are configured to, with the at least one processor, cause the at least one processor to:
based on the received image capture request becoming a top priority rank in the priority queue, identify duplicate requests of the received image capture request in the priority queue; and
remove the identified duplicate requests from the priority queue.

7. The system of claim 1, wherein the at least one memory and the computer program code are configured to, with the at least one processor, cause the at least one processor to:
identify an image spectrum requirement of the received image capture request based on image spectrum data included in the received image capture request;
based on the image capture device of the satellite failing to satisfy the identified image spectrum requirement, send a notification to the ground IoT device, wherein the notification indicates that the satellite cannot process the image capture request; and
wherein capturing the image data of the area is further based on the image capture device of the satellite satisfying the identified image spectrum requirement.

8. The system of claim 1, wherein the response target includes at least one of the following: the ground IoT device, another ground IoT device, a ground station associated with the ground IoT device.

9. A computerized method comprising:
receiving, by a processor of a satellite, an image capture request from a ground Internet-of-Things (IoT) device, the request including request type data, location data, and response target data, wherein the request type data is indicative of a sensor event at the ground IoT device;
capturing, by the processor, using an image capture device of the satellite, image data of an area based on the location data of the image capture request;
generating, by the processor, a response based on the captured image data and on the request type data; and
sending, by the processor, the generated response to a response target based on the response target data of the image capture request.

10. The computerized method of claim 9, wherein the received image capture request includes sensor data source data;
wherein the request type data includes a sensor data fusion indicator;
wherein generating the response further includes:
obtaining sensor data based on the sensor data source data of the image capture request;
combining the obtained sensor data and the captured image data into a sensor data image map based on the sensor data fusion indicator; and
including the sensor data image map in the generated response.

11. The computerized method of claim 10, wherein the request type data includes a data insight request indicator;
wherein generating the response further includes:
generating a data insight from at least one of the obtained sensor data and the captured image data based on the data insight request indicator; and
including the generated data insight in the generated response.

12. The computerized method of claim 10, wherein obtaining the sensor data further includes:
identifying a plurality of sensor devices based on the sensor data source data, wherein the plurality of sensor devices are located in proximity to the area associated with the location data;
requesting sensor data from the identified plurality of sensor devices; and
receiving the requested sensor data.

13. The computerized method of claim 9, further comprising:
adding the received image capture request to a priority queue based on receiving the image capture request, wherein a priority rank of the received image capture request in the priority queue is set based on an expiration time data value included in the received image capture request; and
wherein capturing the image data of the area is based on the received image capture request becoming a top priority rank in the priority queue.

14. The computerized method of claim 13, further comprising:
based on the received image capture request becoming the top priority rank in the priority queue, identifying duplicate requests of the received image capture request in the priority queue; and
removing the identified duplicate requests from the priority queue.

15. The computerized method of claim 9, further comprising:
identifying an image spectrum requirement of the received image capture request based on image spectrum data included in the received image capture request;
based on the image capture device of the satellite failing to satisfy the identified image spectrum requirement, sending a notification to the ground IoT device, wherein the notification indicates that the satellite cannot process the image capture request; and
wherein capturing the image data of the area is further based on the image capture device of the satellite satisfying the identified image spectrum requirement.

16. The computerized method of claim 9, wherein the response target includes at least one of the following: the ground IoT device, another ground IoT device, a ground station associated with the ground IoT device.

17. One or more computer storage media having computer-executable instructions that, upon execution by a processor of a satellite, cause the processor to at least:
receive an image capture request from a ground Internet-of-Things (IoT) device, the request including request type data, location data, and response target data, wherein the request type data is indicative of a sensor event at the ground IoT device;
capture, using an image capture device of the satellite, image data of an area based on the location data of the image capture request;
generate a response based on the captured image data and on the request type data; and
send the generated response to a response target based on the response target data of the image capture request.

18. The one or more computer storage media of claim 17, wherein the received image capture request includes sensor data source data;
wherein the request type data includes a sensor data fusion indicator;
wherein generating the response further includes:
obtaining sensor data based on the sensor data source data of the image capture request;
combining the obtained sensor data and the captured image data into a sensor data image map based on the sensor data fusion indicator; and
including the sensor data image map in the generated response.

19. The one or more computer storage media of claim 18, wherein the request type data includes a data insight request indicator;
wherein generating the response further includes:
generating a data insight from at least one of the obtained sensor data and the captured image data based on the data insight request indicator; and
including the generated data insight in the generated response.

20. The one or more computer storage media of claim 18, wherein obtaining the sensor data further includes:
identifying a plurality of sensor devices based on the sensor data source data, wherein the plurality of sensor devices are located in proximity to the area associated with the location data;
requesting sensor data from the identified plurality of sensor devices; and
receiving the requested sensor data.
